(19) United States
(12) Patent Application Publication
(10) Pub. No.: US 2004/0197482 A1
(43) Pub. Date: Oct. 7, 2004

(54) Coating precursor and method for coating a substrate with a refractory layer

(76) Inventors: Airy-Pierre Lamaze, Saint-Cassien (FR); Christian Barthelemy, Voiron (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/492,523

(22) PCT Filed: Oct. 11, 2002
(86) PCT No.: PCT/FR02/03485

(30) Foreign Application Priority Data
Oct. 15, 2001 (FR) 01/13266

(51) Int. Cl. B05D 3/02; C25D 17/00

(52) U.S. Cl. 427/372.2; 204/279

(57) ABSTRACT

The invention concerns a coating precursor comprising a silicone resin, a metal compound and an organic solvent capable of dissolving said silicone and of suspending said metal compound, said silicone resin and said metal compound being capable of chemically reacting so as to produce a solid layer on a substrate after the organic solvent has evaporated and a cohesive refractory layer after a calcination process. The invention also concerns a method for coating a specific surface of a substrate with at least a refractory silicon-containing layer which consists in coating the substrate with a coating precursor of the invention, so as to form a raw layer and carrying out a heat treatment so as to calcine said raw layer and form a cohesive refractory layer. The invention enables to obtain a protective coating resistant to oxidizing environments, liquid metal or molten salt.

### FIELD OF THE INVENTION

This invention relates to the protection of objects and materials for use for the production of aluminium by molten salt electrolysis, particularly according to the Hall-Heroult process. In particular, it relates to protective coatings for the said objects and materials.

### STATE Of The ART

Aluminium metal is produced industrially by fused bath electrolysis, namely by electrolysis of alumina in solution in a molten cryolite bath called an electrolytic bath, using the well-known Hall-Heroult process. The electrolytic bath is typically contained in pots called “electrolytic pots” comprising a steel pot shell that is coated on the inside with refractory and/or insulating materials, and a cathode assembly that is normally located at the bottom of the pot. The cathode assembly typically comprises pre-baked cathode blocks made of a carbonaceous material. Anodes are partially immersed in the electrolytic bath. The expression “electrolytic cell” normally refers to the assembly comprising an electrolytic pot and one or more anodes.

The objects and materials used in the aluminium industry are frequently exposed to corrosive environments and subjected to high temperatures and severe thermal and mechanical constraints. This is the case particularly for elements of an electrolytic aluminium production cell that are exposed to corrosive action by gaseous effluents (that may contain oxygen, carbon monoxide and/or fluorinated gases), liquid metal at very high temperature (typically up to about 1000° C.) and/or a molten salt (typically molten cryolite). In particular, these elements include anodes, anode stems, internal pot coatings, lining bricks and cathode blocks.

Although the strength of materials typically used in the aluminium industry is generally sufficient, there are some applications or conditions for which an even higher strength is required. This is the case particularly when it is required to reduce the wear of cathodes containing graphite.

Therefore, the applicant looked for means of increasing the chemical resistance, and possibly the mechanical strength, of electrolytic cell elements.

### DESCRIPTION OF THE INVENTION

An object of the invention is a coating precursor comprising a silicone resin (or organosiloxane), a mineral filler and an organic solvent capable of dissolving the said resin and putting the said mineral filler into suspension, the said silicone resin and the said mineral filler being capable of chemically reacting so as to produce a solid layer on a substrate after the organic solvent has evaporated and a cohesive refractory layer after a calcination operation.

The said precursor, which is typically in the form of a slurry or a slip, is preferably homogenous. It is typically obtained by mixing the resin, the mineral filler and the organic solvent.

The silicone resin is a polysiloxane preferably containing a proportion of OH groups, such as a polymethysiloxane, a polydimethylsiloxane, a polymethylsilsesquioxane, or a mixture thereof, comprising a proportion of OH groups substituted for methyl groups. The applicant has noted that the proportion of OH groups is preferably between about 0.5% and about 2%. If the proportion of OH groups is too low, there will not be sufficient propension to form a solid layer after the solvent has evaporated and with good cohesiveness after calcination. A very high proportion of OH groups may make the polysiloxane difficult to make at an acceptable cost. The silanol (Si—OH) groups are preferably stable so that the resin can be stored. These OH groups may be grafted to a polysiloxane by hydrolysis. The siloxanic patterns of the polysiloxane according to the invention are advantageously wholly or partly trifunctional or quadrifunctional.

The proportion of silicone resin in the precursor is typically between 5 and 30% by weight, and preferably between 7.5 and 20% by weight, to enable satisfactory ceramisation of the coating during calcination. Apart from the solvent, the proportion of silicone resin in the precursor is typically between 15 and 40% by weight.

The organic solvent is typically an apolar solvent such as a xylene or a toluene. The xylene may be a mixture of different types of xylene, such as o and p. The proportion of solvent in the precursor is typically between 20 and 60% by weight, and even typically between 30% and 55% by weight.

The mineral filler is typically chosen from among borides, carbides, nitrides and oxides of metals, or from among borides, carbides and nitrides of non-metals (such as boron nitrides and boron carbides (B₄C, etc.)) or a combination or a mixture thereof. The said mineral filler is advantageously chosen from among metal compounds such as metal oxides, metal carbides, metal borides and metal nitrides, or a combination or a thereof. The mineral filler is preferably capable of chemically reacting with the silicone resin so as to produce a solid layer after evaporation of the organic solvent and a refractory layer with strong cohesiveness after calcination of the said green layer.

The metal compound is advantageously alumina, ZrO₂, ZrB₂, TiB₂ or TiO₂ or a combination or a mixture thereof. The alumina is preferably a reactive calcinated alpha alumina called technical alumina, with a very low hydration ratio (typically less than 1%, or even less than 0.5%).

The proportion of mineral filler in the precursor is typically between 30% and 55% by weight. If the proportion is too low, the deposition will be too thin and consequently it will be necessary to deposit a large number of layers in succession. If the proportion is too large, the precursor will be difficult to spread.

The mineral filler is preferably in the form of a fine powder, which can give a fluid precursor and a uniform coating. It is typically added to the silicone resin/organic solvent mixture after a fine grinding operation. The size grading of the mineral filler powder is typically such that the size of the grains is between 0.05 μm and 5 μm.

Another object of the invention is a process for coating a given surface of a substrate with at least one refractory layer containing silicon in which:

the substrate is coated with a coating precursor according to the invention so as to form a green layer;

a heat treatment called calcination treatment is carried out to eliminate volatile materials, to calcinate the said green layer and to form a cohesive refractory layer.

The applicant has observed that the process of the invention can give a strong thin layer bonding strongly to the substrate that has good resistance to liquid metal and/or oxidation and that has good cohesiveness.

The quantity of the said organic solvent is preferably such that the entire silicone resin is dissolved and the mineral filler can be put into suspension in the solution obtained.

The coating precursor may be prepared in at least two operations:

a silicone resin is dissolved in an organic solvent so as to obtain a solution of silicone resin;

the mineral filler is added into the solution of silicone resin thus obtained.

The substrate may be coated (typically including the deposition and spreading of the said precursor on the substrate) by any known means. For example, the coating may be deposited by brushing (typically using a brush and/or a roller), by dipping, by atomisation or by spraying (typically using a spray gun). The temperature of the substrate may possibly be increased above the ambient temperature before coating in order to facilitate the formation of a homogenous deposit and bonding of the deposition by melting of the resin.

The process according to the invention may also comprise complementary operations such as preparation of the parts of the substrate surface to be coated and/or drying of the green coating before the heat treatment. The purpose of the said drying treatment is in particular to evaporate the said organic solvent and to solidify, at least partially, the green layer (so that the substrate can be manipulated without damaging the layer). The preparation of the substrate surface typically includes cleaning and/or degreasing (for example using acetone).

In some applications, it may be advantageous to use a coating precursor also containing a wetting agent capable of facilitating the formation of a thin layer. The said wetting agent is preferably a silane polyether, which encourages spreading of the coating on the substrate without preventing ceramisation of the refractory coating during the heat treatment. The chemical formula of the said silane polyether is typically:

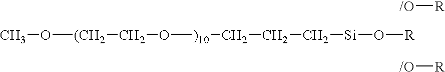

where R is an alkyl group and typically a methyl.

Advantageously, the wetting agent also prevents or significantly delays the precursor caking.

The proportion of wetting agent in the precursor is typically between about 1 and 5% by weight, and is preferably between 2 and 3% by weight in proportion to the mineral filler. Compared with the total weight of the precursor, the proportion of wetting agent in the precursor is typically between 0.5 and 5% and preferably between 1 and 3% by weight.

The so-called calcination heat treatment comprises at least one step at a high temperature, typically between 800 and 1300° C., capable of transforming the green layer into a refractory ceramic, that is advantageously in the vitreous state. The composition of the vitreous phase typically comprises between 5 and 25% by weight of silica obtained from the resin (the remainder, typically 75 to 95% by weight, consists essentially of the mineral filler). The calcination temperature also depends on the substrate; for example, in the case of a metallic substrate, it is advantageously less than the softening temperature of the substrate. Furthermore, it is also preferable to use a calcination temperature greater than the working temperature of the coated substrate. The heat treatment may include an intermediate step at a temperature of between 200 and 600° C. (typically between 200 and 250° C.). This intermediate step is preferably capable of causing cross linking of the resin, and possibly decomposition of the resin, before “ceramisation” (or final calcination) of the coating. In this case, it is possible, according to an advantageous variant of the invention, to continue in situ calcination heat treatment, in other words when using the substrate at high temperature (preferably higher than 650° C.).

The duration of the heat treatment is preferably such that it enables complete ceramisation of the precursor. The temperature increase is preferably sufficiently low to prevent the coating from cracking.

During the heat treatment, the organic compounds are eliminated (by evaporation and/or by decomposition) leaving a refractory solid on a surface of the substrate. For example, this solid may be formed from metal originating from the metal compound and silicon originating from the silicone resin. In the case of alumina, silanol groups Si—OH of the polysiloxane seem to create covalent links with the OH groups of alumina, the said links seem to transform into Si—O—Al links with release of water, during the heat treatment to form an aluminosilicate, which is advantageously in the vitreous state. A similar mechanism may occur with metal compounds other than alumina.

The ambient atmosphere during the calcination treatment is advantageously non-oxidizing, particularly to prevent oxidation of the substrate at the substrate-coating interface that could cause decohesion between the substrate and the coating, or even destruction of the substrate (for example when the substrate is made of graphite).

The final coating may comprise two or more successive layers that may be applied by coatings and successive heat treatments, i.e. by successive coating/heat treatment sequences. In other words, the layer coating and calcination treatment operations are repeated for each elementary layer in the final coating. The successive layers may have a different composition, so as to confer different chemical and mechanical properties. This variant provides a means of adapting each layer to a local function, such as bond to the substrate for the first layer, mechanical strength for intermediate layers and chemical resistance for the surface layer.

The substrate may be made of metal, a refractory material or a carbonaceous material, or a mixture or a combination thereof. The substrate may be an element of a molten salt electrolytic cell for the production of aluminium.

Another object of the invention is an element of a molten salt electrolytic cell for the production of aluminium in which at least part of the surface comprises at least one refractory layer obtained using the said precursor or using the said coating process, the said refractory layer being advantageously in the vitreous state, with or without a gradient of the composition in the direction perpendicular to the surface of the substrate.

Another object of the invention is the use of the said precursor or the said coating process for the protection of a material and/or an element of a molten salt electrolytic cell for the production of aluminium.

The element of a molten salt electrolytic cell for the production of aluminium may be made of metal, a refractory material or a carbonaceous material (such as graphite) or a mixture or combination thereof; it may be a particular object, particularly a carbonaceous material anode, a support element for an anode (such as an anode stem or an anode pin), an element or part of an electrolytic pot (such as a pot shell or a pot shell deck plate), a coating element of an electrolytic pot (such as a refractory brick or a lining element), a cathode block made of a carbonaceous material or a mixture of carbonaceous materials (such as a cathode block made at least partially of graphite). The substrate may be porous or non-porous.

Another object of the invention is a molten salt electrolytic cell for the production of aluminium comprising at least one material and/or element according to the invention.

Tests

Test 1

This test was performed on graphite blocks with dimensions of about 50×15×15 mm.

A slip was prepared with the following composition:

mineral filler (a metal compound): 44.9% by weight of a TiB₂ type powder (reference Metabap 143) with a D₅₀ of 1.7 μm;

silicone resin: 14% by weight of a polymethylsiloxane MK made by the Wacker company, which is a trifunctional resin with about 1% of OH groups. This resin was composed of about 80% silica equivalent and 20% of methyl groups, which decompose at a temperature of the order of 450° C.;

organic solvent: 39.8% by weight of xylene;

wetting agent: 1.35% by weight of polysilane Dynasylan® 4140 made by the Degussa-Huls company (about 3% by weight in comparison with the quantity of TiB₂ in all cases).

These proportions were such that the refractory coating obtained included about 80% by weight of the metal compound equivalent and 20% by weight of the silica equivalent. The concentration of silicone resin in the xylene was about 250 g/l.

The xylene was mixed so as to obtain a homogenous mixture. The silicone resin was dissolved in this organic solvent at ambient temperature until a homogenous solution was obtained. The wetting agent was then added to this solution. After a 10-minute maturing time, the filler was added to this solution and mixed (by stirring) until a homogenous slurry was obtained.

Two blocks of graphite (block 1 and block 2) were covered with a brush with two successive layers of the slip thus obtained. The blocks were dried at 100° C. after each deposit.

Two other blocks of graphite (block 3 and block 4) were coated with two successive layers of the same slip applied with a brush. The blocks were subjected to a calcination operation at 900° C. under argon, after each deposit.

These four blocks (blocks No. 1 to 4) and an uncoated control block (block No. 5) were subjected to an oxidation resistance test consisting of increasing their temperature to 720° C. in the presence of air for 48 hours. After this test, the control block (No. 5) was reduced to ash; blocks No. 1 and 2 had lost 70% of their weight and blocks No. 3 and 4 had lost 3.5 and 8% of their weight, respectively. A careful examination of the latter two blocks showed that the loss of weight for block No. 3 was associated with two points with a diameter of about 1 mm at which the surface was not coated, and that for block No. 4, the loss of weight was due to a lack of deposition at one of the corners of the block. Therefore, the coatings of blocks No. 3 and 4 provide an excellent protection against oxidation that the applicant considers is due to the formation of a protective refractory layer during the calcination operation.

Test 2

This test was made on stainless steel thin plates with dimensions of about 1×12×20 mm.

A slip was prepared using the same procedure as for test 1, with the following composition:

metal compound filler: 44.9% by weight of a calcinated alpha alumina powder (technical alumina reference P172SB made by the Aluminium Pechiney company), with a D₅₀ of 0.5 μm and a specific area BET of 6 to 8 m²/g. The alumina was finely ground (size grading typically between 0.2 μm and 1.5 μm);

silicone resin: 14% by weight of an MK polymethylsiloxane made by the Wacker company, which is a trifunctional resin with about 1% of OH groups. This resin was composed of about 80% silica equivalent and 20% of methyl groups, which decompose at a temperature of the order of 450° C.;

organic solvent: 39.8% by weight of xylene;

wetting agent: 1.35% by weight of polysilane Dynasylan® 4140 made by the Degussa-Huls company (about 3% by weight in comparison with the quantity of TiB₂ in all cases).

A plate was covered with four successive layers of the slip thus obtained. The plate was subjected to a calcination operation at 900° C. after each deposition.

The coated plate and an uncoated control plate were tested by immersion for 8 hours in a liquid aluminium flow at about 750° C. The coated plate was hardly attacked by the liquid metal while the uncoated plate was largely dissolved in the liquid metal.

1. A process for coating a given surface of an element of a molten salt electrolytic cell for the production of aluminum with at least one refractory layer containing silicon, said process comprising:
preparing a coating precursor comprising a silicone resin, a mineral filler and an organic solvent capable of dissolving the said resin and putting the mineral filler into suspension, the silicone resin and the mineral filler being capable of chemically reacting so as to produce a solid layer on a substrate after the organic solvent has evaporated and a cohesive refractory layer after a calcination operation, said resin being a polymethylsiloxane or a polymethylsilsesquioxane, or a mixture thereof, wherein a proportion of OH groups is substituted for methyl groups;
coating the surface with the coating precursor, so as to form a green layer;
carrying out a heat treatment called calcination treatment to eliminate volatile materials, to calcinate the green layer and to form a cohesive refractory layer.

2. A process for coating according to claim 1, wherein siloxanic patterns of the silicone resin include trifunctional or quadrifunctional patterns.

3. A process for coating according to claim 1 wherein the proportion of OH groups is between about 0.5% and about 2%.

4. A process for coating according to claim 1 wherein the said organic solvent is apolar.

5. A process according to claim 4, wherein the organic apolar solvent is a xylene or a toluene.

6. A process according to claim 1 wherein the proportion of organic solvent in the coating precursor is between 20% and 60% by weight.

7. A process according to claim 1 to 6, wherein the proportion of the mineral filler is present in an amount between 30% and 55% by weight.

8. A process for coating according to claim 1 wherein the mineral filler is at least one selected from the group consisting of metal oxides, metal and non-metal carbides, metal and non-metal borides and metal and non-metal nitrides.

9. A process for coating according to claim 8, wherein the mineral filler comprises a calcinated alpha alumina.

10. A process for coating according to claim 9 wherein the mineral filler is at least one selected from the group consisting of ZrO₂, ZrB₂, TiB₂ or TiO₂, boron nitride, and boron carbide.

11. A process for coating according to claim 1 wherein the mineral filler is in the form of a fine powder for which the size of the grains is between 0.05 μm and 5 μm.

12. A process according to claim 1 wherein the proportion of silicone resin in the coating precursor is between 5% and 30% by weight.

13. A process for coating according to claim 1 wherein the coating precursor further comprises a wetting agent capable of facilitating the formation of a thin layer.

14. A process for coating according to claim 13, wherein the wetting agent is a silane polyether.

15. A process for coating according to claim 13, wherein the proportion of wetting agent in the coating precursor is between about 0.5 and 5%.

16. A process according to claim 1 wherein the coating precursor is in the form of a slurry or a slip.

17. A process according to any one of claim 1 further comprising preparing the substrate surface before coating.

18. A process according to claim 1 wherein the coating is deposited by brushing, by dipping, by atomisation or by spraying.

19. A process according to any one of claim 1 wherein the temperature of the substrate is increased above the ambient temperature before coating.

20. A process according to claim 1 wherein the green layer is dried before the calcination treatment.

21. A process according to claim 1 wherein the calcination treatment comprises at least one step at a temperature of between 800 and 1300° C. capable of transforming the green layer into a refractory ceramic.

22. A process according to claim 1 wherein ambient atmosphere during the calcination treatment is non-oxidizing.

23. A process according to claim 1 wherein the refractory layer is formed from several successive layers.

24. A process according to claim 1 wherein the substrate is made of metal, a refractory material or a carbonaceous material, or a mixture or combination thereof.

25. A process according to claim 1 wherein the substrate comprises an element of a carbonaceous material anode, a support element for an anode, an element or a part of an electrolytic pot, a coating element of an electrolytic pot and/or a cathode block made of a carbonaceous material.

26. An element of a molten salt electrolytic cell suitable for the production of aluminum, wherein at least part of a surface thereof comprises at least one refractory layer obtained using a process according to claim 1.

27. An element according to claim 26, wherein said element is made of metal, a refractory material or a carbonaceous material, or a mixture or a combination thereof.

28. An element according to claim 26, wherein said element is at least one selected from the group comprising carbonaceous material anodes, support elements for an anode, elements or parts of an electrolytic pot, coating elements of an electrolytic pot and cathode blocks made of a carbonaceous material and a mixture of carbonaceous materials.

29. An element according to claim 28, wherein the sa support elements for an anode are selected from the group consisting of anode stems and anode pins.

30. An element according to claim 28, wherein the elements or parts of the electrolytic pot are selected from the group consisting of pot shells and pot shell deck plates.

31. An element according to claim 28, wherein the coating elements are selected from the group consisting of refractory bricks and lining elements.

32. An element according to claim 28, wherein the cathode blocks contain graphite.

33. A molten salt electrolytic cell suitable for the production of aluminum comprising at least one element according to claim 26.

34. A coating precursor comprising a silicone resin, a mineral filler and an organic solvent capable of dissolving the said resin and putting the mineral filler into suspension, the silicone resin and the mineral filler being capable of chemically reacting so as to produce a solid layer on a substrate after the organic solvent has evaporated and a cohesive refractory layer after a calcination operation.

35. A coating precursor according to claim 34, wherein siloxanic patterns of the silicone resin include trifunctional or quadrifunctional patterns.

36. A coating precursor according to claim 34, wherein the silicone resin is a polysiloxane comprising a proportion of OH groups.

37. A coating precursor according to claim 36, wherein the polysiloxane is a polymethylsiloxane, a polydimethylsiloxane, a polymethylsilsesquioxane, or a mixture thereof, wherein a proportion of OH groups is substituted for methyl groups.

38. A coating precursor according to claim 36, wherein the proportion of OH groups is between about 0.5% and about 2%.

39. A coating precursor according to claim 34, wherein the organic solvent is apolar.

40. A coating precursor according to claim 39, wherein the organic apolar solvent is a xylene or a toluene.

41. A coating precursor according to claim 34, wherein the proportion of solvent in the precursor is between 20% and 60% by weight.

42. A coating precursor according to claim 34, wherein the proportion of the mineral filler is between 30% and 55% by weight.

43. A coating precursor according to claim 34, wherein the mineral filler comprises at least one selected from the group consisting of metal oxides, metal and non-metal carbides, metal and non-metal borides and metal and non-metal nitrides.

44. A coating precursor according to claim 43, wherein the mineral filler comprises a calcinated alpha alumina.

45. A coating precursor according to claim 43, wherein the mineral filler comprises at least one selected from the group consisting of ZrO₂, ZrB₂, TiB₂ or TiO₂, boron nitride, and boron carbide.

46. A coating precursor according to claim 34, wherein the mineral filler is in the form of a fine powder for which the size of the grains is between 0.05 μm and 5 μm.

47. A coating precursor according to claim 34, wherein the proportion of silicone resin in the coating precursor is between 5% and 30% by weight.

48. A coating precursor according to claim 34, wherein the coating precursor also contains a wetting agent capable of facilitating the formation of a thin layer.

49. A coating precursor according to claim 48, wherein the wetting agent is a silane polyether.

50. A coating precursor according to claim 48, wherein the proportion of wetting agent in the precursor is between about 0.5 and 5%.

51. A coating precursor according to claim 34, wherein said coating precursor is in the form of a slurry or a slip.

52. A process for coating a given surface of a substrate with at least one refractory layer containing silicon comprising:
coating the surface with a coating precursor according to claim 34, so as to form a green layer;
carrying out a heat treatment called calcination treatment to eliminate volatile materials, to calcinate the green layer and to form a cohesive refractory layer.

53. A process according to claim 52, further comprising preparing the substrate surface before coating.

54. A process according to claim 52, wherein the coating is deposited by brushing, by dipping, by atomisation or by spraying.

55. A process according to claim 52, wherein the temperature of the substrate is increased above ambient temperature before coating.

56. A process according to claim 52, wherein the green layer is dried before the calcination treatment.

57. A process according to claim 52, wherein the calcination treatment comprises at least one step at a temperature of between 800 and 1300° C. capable of transforming the green layer into a refractory ceramic.

58. A process according to claim 52, wherein ambient atmosphere during the said calcination treatment is non-oxidizing.

59. A process according to claim 52, wherein the refractory layer is formed from several successive layers.

60. A process according to claim 52, wherein the substrate is made of metal, a refractory material, a carbonaceous material, or a mixture or combination thereof.

61. A process according to claim 52, wherein the substrate is an element of a molten salt electrolytic cell suitable for the production of aluminum.

62. A process according to claim 61, wherein the element is a carbonaceous material anode, a support element for an anode, a coating element of an electrolytic pot and/or a cathode block made of a carbonaceous material.

63. A method for using a coating precursor according to claim 34 comprising protecting a material and/or an element of a molten salt electrolytic cell for the production of aluminum.

64. A method according to claim 63, wherein the material is a metal, a refractory, a carbonaceous material, or a mixture or a combination thereof.

65. A method according to claim 63, wherein the element is a carbonaceous material anode, a support element for an anode, an element or part of an electrolytic cell, a coating element of an electrolytic pot and/or a cathode block made of a carbonaceous material.

66. An element of a molten salt electrolytic cell suitable for the production of aluminum, wherein at least part of a surface thereof comprises at least one refractory layer obtained using a coating precursor according to claim 34.

67. An element according to claim 66, wherein said element is made of metal, a refractory material, a carbonaceous material, or a mixture or a combination thereof.

68. An element according to claim 66, wherein said element is selected from the group consisting of carbonaceous material anodes, support elements for an anode, elements or parts of an electrolytic pot, coating elements of an electrolytic pot and cathode blocks made of a carbonaceous material and a mixture of carbonaceous materials.

69. An element according to claim 68, wherein the support elements for an anode are selected from the group consisting of anode stems and anode pins.

70. An element according to claim 68, wherein the elements or parts of the electrolytic pot are selected from the group consisting of pot shells and pot shell deck plates.

71. An element according to claim 68, wherein the coating elements are selected from the group consisting of refractory bricks and lining elements.

72. An element according to claim 68, wherein the cathode blocks contain graphite.

73. A molten salt electrolytic cell for the production of aluminum comprising at least one element according to claim 66.
